(19) United States
(12) Patent Application Publication
(10) Pub. No.: US 2014/0193663 A1
(43) Pub. Date: Jul. 10, 2014

(54) NON-FLAMMABLE SUBSTRATE AND METALLIC APRON TABLE CONSTRUCTION

(71) Applicant: Martin Robert Jewett, Flagstaff, AZ (US)

(72) Inventor: Martin Robert Jewett, Flagstaff, AZ (US)

(21) Appl. No.: 13/736,936

(22) Filed: Jan. 8, 2013

(51) Int. Cl. A47B 13/08; B32B 15/01

(52) U.S. Cl. CPC A47B 13/08; B32B 15/01
USPC 428/615; 420/591

(57) ABSTRACT

An embodiment of a metallic table constructed with a Non-Flammable Substrate 101 used as the internal structure for a Metallic Table Top 201, including a Metallic Table Apron 301. The Metallic Table Apron 301 may be joined to the Metallic Table Top 201 by welding, brazing, or other methods without causing damage or ignition to the Non-Flammable Substrate 101. The Metallic Table Apron 301 increases the visible thickness and decorative variety of a metallic table for decorative purposes without obtrusively increasing the weight or manufacturing cost of a metallic table.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

### Prior Art

Historically, four legged tables were first seen in ancient Egypt and were usually only used to support objects. The table evolved through the Greek Empire, Roman Empire, and Middle Ages, eventually developing the long banquet Refectory table in the 17th century. In modern times metallic table finishes have gained greater popularity due to advanced and cheaper manufacturing processes, cheaper materials, and the increasing contemporary use of metals in building and decoration.

The modern metallic table top creates a trade off of problems for the manufacturer and consumer; they can be sturdy but heavy, or they can be lightweight but flimsy. A perfect table must not only support its own weight, but also support people or things with enough structural rigidity to feel solid and give the user confidence. To best solve this tradeoff metallic table tops are being manufactured with a wooden structure inside the table top. In this method, a thin layer of the desired metal is formed over a wooden structure. This solution provides a relatively lightweight table top, yet it still appears to be manufactured from a metallic slab.

New trends in furniture style present a new problem to the metallic table, the table top can only be made as thick as the wooden structure upon which the top is built. If the wooden structure was made thicker, it would increase the table top weight to an unfeasible amount. No additional material can be welded or brazed to the table top due to the flammable wooden structure. Due to this, current table top are limited to the thickness of the wooden structure.

The wooden structure design limits current metallic table tops to a slab design. Metallic tables built over a wood structure are manufactured from a single large sheet of the desired metal. This thin sheet of metal is cut into a shape that is folded over the wooden structure and welded only at the corners. By performing minimal welding at the corners, the tables can be manufactured with minimal damage to and scorching of the internal wooden structure. Manufacturers can only put limited texture or design on the table sides because the decorations must be applied before the metal is formed over the wooden structure. Textures, designs, or embosses may be damaged during folding or may not line up with the table edges when the table top is finished.

The building process of metallic tables, especially those with pliable or malleable metals, limits these to a slab design with no relief or recess in the table's edges. The edges of a slab design table are planar and cannot recess back under the table. Since the sides of a metallic table cannot be intricately decorated or recessed, the sides are usually left flat and featureless and are not able to contribute any decoration to the table.

With the above limits on the construction of metallic table tops, current metallic tables tops cannot achieve the same designs as tables of wooden construction. This lack of table top thickness or recessed aprons creates a simple and cheap appearance on most tables. To mitigate this issue, tables are being built with both metal and wood materials. Some builders are manufacturing metallic table tops with wooden aprons so that decorative and recessed aprons can be added, albeit of wood. But, purely metallic tables are still incapable of the thickness and intricate decorations of wooden tables.

### SUMMARY

The Non-Flammable Substrate and Welded Table Apron Construction table design allows for a metallic apron to be permanently joined to the metallic table top without damage to the non-metallic table structure. To be clear, the term non-flammable in this document is defined as, “will not readily or easily burn, noncombustible, or fireproof”.

The attachment of a metallic apron to a metallic table increases the visual thickness and decoration of the table. Because the metallic apron can be manufactured separately and attached to the table after it has been formed around the substrate, it can be built with intricate decorations. The metallic apron can provide heavily embossed decoration, textures, and recesses to improve the visual appearance of the table sides and. With separate metallic aprons, metallic tables would not have to be simple slab designs. The metallic apron also provides an enclosure inside which the table's leg mounting structure can be hidden.

By using a non-flammable substrate in the metallic table top, the metallic apron can be welded, brazed, or otherwise permanently joined to the table top. Heat transferred through the exterior metal to the non-flammable substrate by this process will not cause damage or ignition of the substrate. By adding the metallic apron to the table, the visual thickness and decoration of the table can be increased.

### DRAWINGS

### Figures

In the drawings, closely related figures pertaining to the same part have the same number but different alphabetic suffixes.

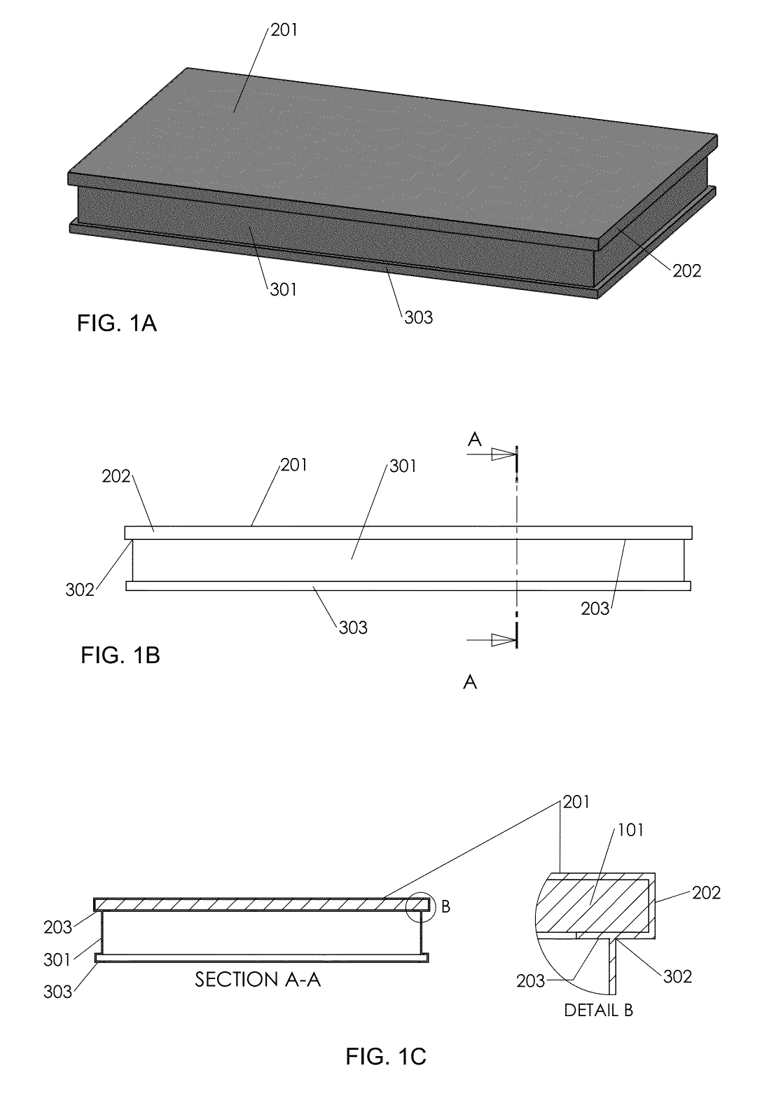

Drawing FIG. 1A is a dimetric view example of a metallic table top with an attached metallic apron. No hidden lines are shown in this view to provide a clear example of the metallic table top exterior.

Drawing FIG. 1B is a right orthogonal view example of the metallic table top with an attached metallic apron. No hidden lines are shown in this view. Section line A-A is shown in this figure, the section view is located in FIG. 1C.

Drawing FIG. 1C is a section view of the metallic table top, metallic apron, and non-flammable substrate. An additional detail view is shown in this figure, labeled Detail B.

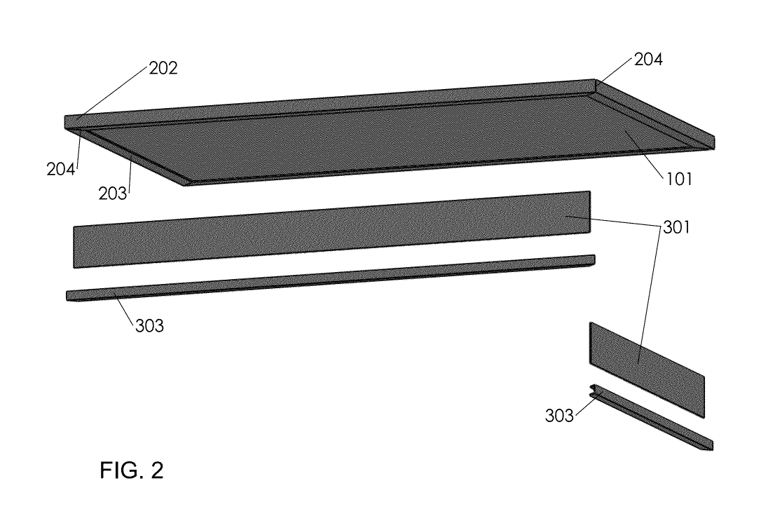

Drawing FIG. 2 is a dimetric, exploded view of the bottom of the metallic table. In this view, the metallic apron and trim have not been affixed to the table to illustrate that the metallic table top is constructed before the metallic apron is attached.

### DRAWINGS

### Reference Numerals

| | |
|---|---|
| 101 - Non-Flammable Substrate | 201 - Metallic Table Top |
| 202 - Metallic Table Top Edge | 203 - Metallic Table Top Retention Lip |
| 204 - Metallic Table Top Corner | 301 - Metallic Table Apron |
| Joint | |
| 302 - Apron to Table Joint | 303 - Metallic Apron Trim |

### DETAILED DESCRIPTION

To be clear, the term non-flammable used in this document is defined as, “will not readily or easily burn, noncombustible, or fireproof”.

One embodiment of Non-Flammable Substrate and Welded Apron Table is shown in FIGS. 1A-1C. In this embodiment The Non-flammable Substrate and Welded Apron Table, herein referred to as “The Table”, is similar to a coffee table top in size and is detailed with seven important features. FIG. 2 shows an exploded view to help explain the construction process to build the The Table and its advantages. The Table has be separated into three important sections by detail reference numerals; 100 numerals include the Non-Flammable Substrate, 200 numerals include the metal table top (the external metallic surface around the substrate), and 300 numerals include the table apron.

The Metallic Table Top 201 is the top slab section of The Table; including the internal Non-Flammable Substrate 101, the Metallic Table Top Edges 202, and Metallic Table Top Retention Lips 203. The Metallic Table Top Edges 202 are the vertical faces of the Metallic Table Top 201. The Metallic Table Top Retention Lips 203, are the sections of sheet metal folded over the Non-Flammable Substrate 101 on the bottom of the Metallic Table Top 201. The Metallic Table Top Corner Joints 204 join the Metallic Table Top Edges 202 and Retention Lips 203 at each corner. The Metallic Table Apron 301 is an additional piece of metal added to the Metallic Table Top 201 for decoration. The Metallic Table Apron 301 is attached to the Metallic Table Top Retention Lips 203 by the Apron to Table Joint 302. The Metallic Apron Trim 303 can be added to the Metallic Table Apron 301 for additional decoration.

The Non-Flammable Substrate 101 is the lightweight internal structure for the Metallic Table Top 201. The substrate forms the internal core of the table top, as shown in FIG. 1C. The Non-Flammable Substrate 101 can be made of any rigid non-flammable material; in one embodiment the Non-Flammable Substrate 101 can be manufactured from magnesium oxide fiber board. This magnesium oxide fiberboard provides a similar weight and strength as plywood, but is non-flammable and can withstand welding and brazing. The Non-Flammable Substrate 101 shown in FIG. 1 is used to form the table top and can serve as a material to affix table legs to.

The Metallic Table Top 201 is manufactured by forming a thin layer of sheet metal over the Non-Flammable Substrate 101. The sheet metal exterior is constructed from a single sheet of metal, including the Metallic Table Top Edge 202 and the Metallic Table Top Retention Lip 203. The sheet metal is cut into an unfolded shape, with each side's Metallic Table Top Edge 202 and Metallic Table Top Retention Lip 203 attached to the top face of the Metallic Table Top 201. The Metallic Table Top Edges 202 are folded around the Substrate 101, and the Metallic Table Top Retention Lips 203 are folder over the Substrate 101. Then, the Metallic Table Top Corner Joints 204 are welded, braised, or otherwise joined to permanently fix the Metallic Table Top Edges 202 and Retention Lips 203 in place. The Non-Flammable Substrate 101 is permanently retained in the metal covering by the fixed Metallic Table Top Edges 202 and Retention Lips 203. Any intense heat generated during welding, brazing, or otherwise joining the Metallic Table Top Corner Joints 204 will not damage or ignite the internal Non-Flammable Substrate 101.

The Metallic Table Apron 301 will be attached to the Metallic Table Top 201 to increase the visual thickness and decorative options of the table. The Metallic Table Apron 301 and Apron Trim 303 shall be attached to the Metallic Table Top 201 by the Apron to Table Joint 302. The Apron to Table Joint 302 may be welded, brazed, or otherwise permanently joined. With the Non-Flammable Substrate 101, the metallic apron can be joined to the metallic table top by processes that create intense heat without causing damage or ignition of the substrate.

By attaching the Metallic Table Apron 301 and Apron Trim 303 after the Metallic Table Top 201 is constructed, the Metallic Table Apron 301 can add a variety of decorations that cannot be applied to the Metallic Table Top Edge 202. The Metallic Table Apron 301 can be heavily embossed or recessed for decoration of The Table. With the additional Metallic Apron Trim 303, the Metallic Table Apron 301 can be recessed to create a dado on the sides of The Table for decoration.

With the above features, the visual thickness and variety of decoration of The Table can be increased without an obtrusive increase in the weight or cost of The Table.

1-4. (canceled)

5. A table top, comprising:
sheet stock, formed of a first material, applied over a substrate, formed of a second material, so as to form a table top;
the first material is a metal; and
the second material is different from the first material and is non-flammable and resistant to heat applied to the sheet stock, such as from welding or brazing.

6. The table top according to claim 5, wherein the second material is magnesium oxide fiber board.

7. The table top according to claim 5, wherein the sheet stock includes edges extending between a top and retention lips that together are applied over and hold the substrate.

8. The table top according to claim 7, further including a metal apron depending downwardly from the retention lips.

9. A method of manufacturing a table top, comprising:
providing sheet stock formed of a first material;
providing a substrate formed of a second material different from the first material; and
forming the sheet stock over the substrate so as to form a table top, wherein the first material is a metal, and the second material is non-flammable and resistant to heat applied to the sheet stock, such as from welding or brazing.

10. The method according to claim 9, wherein the second material is magnesium oxide fiber board.

11. The method according to claim 10, wherein the step of forming the sheet stock over the substrate further includes folding the sheet stock over the substrate so as to form in the sheet stock edges extending between a top and retention lips that together are applied over and hold the substrate.

12. The method according to claim 11, further comprising attaching a metal apron to the retention lips via the application of heat, such as by welding or brazing, and the substrate withstanding said heat so as to resist burning, wherein the apron depends downwardly from the retention lips.
